(19) United States
(12) Patent Application Publication
(10) Pub. No.: US 2026/0333227 A1
(43) Pub. Date: Oct. 22, 2026

(54) SYNCHRONIZATION SIGNALS FOR WAKE UP SIGNAL AND PHYSICAL CHANNEL MONITORING

(71) Applicant: Lenovo (United States) Inc., Morrisville, NC (US)

(72) Inventors: Karthikeyan Ganesan, Nauheim (DE); Ravi Kuchibhotla, Chicago, IL (US)

(73) Assignee: Lenovo (United States) Inc., Morrisville, NC (US)

(21) Appl. No.: 19/566,241

(22) Filed: Mar. 13, 2026

(51) Int. Cl. H04W 52/02; H04W 56/00; H04W 72/231; H04W 76/28

(52) U.S. Cl. CPC H04W 52/0235; H04W 56/0015; H04W 72/231; H04W 76/28

(57) ABSTRACT

Various aspects of the present disclosure relate to synchronization signals (SSs) for wake up signal (WUS) and physical channel monitoring. A UE receives one or more first SSs. The UE receives a WUS based on the one or more first SSs. The UE receives, during a time window that occurs after reception of the wakeup signal, one or more second SSs. The UE communicates, during the time window and based on the one or more second synchronization signals, one or more physical channel signals, where the one or more physical channel signals include one or more uplink data signals, one or more downlink data signals, or one or more downlink control signals.

### TECHNICAL FIELD

The present disclosure relates to wireless communications, and more specifically to synchronization signals (SSs) for wake up signal (WUS) and physical channel monitoring.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The device (e.g., NE or UE), processors, and methods of the present disclosure each have several innovative aspects, no single of which is solely responsible for the desirable features disclosed herein.

A UE for wireless communication is described. The UE may be configured to, capable of, or operable to perform one or more operations as described herein. For example, the UE may be configured to, capable of, or operable to receive one or more first SSs, receive a WUS based on the one or more first SSs, receive, during a time window that occurs after reception of the WUS, one or more second SSs, and communicate, during the time window and based on the one or more second SSs, one or more physical channel signals, where the one or more physical channel signals include one or more uplink data signals, one or more downlink data signals, or one or more downlink control signals.

A processor (e.g., a standalone processor chipset, or a component of the UE) for wireless communication is described. The processor may be configured to, capable of, or operable to perform one or more operations as described herein. For example, the processor may be configured to, capable of, or operable to receive one or more first SSs, receive a WUS based on the one or more first SSs, receive, during a time window that occurs after reception of the WUS, one or more second SSs, and communicate, during the time window and based on the one or more second SSs, one or more physical channel signals, where the one or more physical channel signals include one or more uplink data signals, one or more downlink data signals, or one or more downlink control signals.

A method performed or performable by a UE for wireless communication is described. The method may include receiving one or more first SSs, receiving a WUS based on the one or more first SSs, receiving, during a time window that occurs after reception of the WUS, one or more second SSs, and communicating, during the time window and based on the one or more second SSs, one or more physical channel signals, where the one or more physical channel signals include one or more uplink data signals, one or more downlink data signals, or one or more downlink control signals.

In some implementations, the UE, the processor, and the method may further be configured to, capable of, or operable to initiate a timer based on the WUS, where the time window spans a duration of the timer or initiate the timer prior to reception of the one or more first SSs. In some implementations, the duration of the timer includes an active period of a connected discontinuous reception (C-DRX) cycle.

In some implementations, the UE, the processor, and the method may further be configured to, capable of, or operable to receive the one or more second SSs until expiration of the timer or receive the one or more second SSs until an end of a C-DRX cycle corresponding to the WUS. In some implementations, the WUS includes a trigger that initiates the timer or reception of the one or more second SSs or start timing symbols and/or slots about reception of the one or more second SSs, including an offset from the reception of the WUS or an offset from a start of the timer.

In some implementations, the UE, the processor, and the method may further be configured to, capable of, or operable to receive the one or more second SSs according to periodicity. In some implementations, the UE, the processor, and the method may further be configured to, capable of, or operable to receive a respective second SS of the one or more second SSs prior to communication of the one or more physical channel signals. In some implementations, the UE, the processor, and the method may further be configured to, capable of, or operable to receive multiple SS blocks (SSBs) according to a periodicity, where the periodicity is based on a reception rate of the WUS.

An NE (e.g., a base station) for wireless communication is described. The NE may be configured to, capable of, or operable to perform one or more operations as described herein. For example, the NE may be configured to, capable of, or operable to transmit one or more first SSs, transmit a WUS based on the one or more first SSs, transmit, during a time window that occurs after transmission of the WUS, one or more second SSs, and communicate, during the time window and based on the one or more second SSs, one or more physical channel signals, where the one or more physical channel signals include one or more uplink data signals, one or more downlink data signals, or one or more downlink control signals.

A processor (e.g., a standalone processor chipset, or a component of an NE) for wireless communication is described. The processor may be configured to, capable of, or operable to perform one or more operations as described herein. For example, the processor may be configured to, capable of, or operable to transmit one or more first SSs, transmit a WUS based on the one or more first SSs, transmit, during a time window that occurs after transmission of the WUS, one or more second SSs, and communicate, during the time window and based on the one or more second SSs, one or more physical channel signals, where the one or more physical channel signals include one or more uplink data signals, one or more downlink data signals, or one or more downlink control signals.

A method performed or performable by an NE (e.g., a base station) for wireless communication is described. The method may include transmitting one or more first SSs, transmitting a WUS based on the one or more first SSs, transmitting, during a time window that occurs after transmission of the WUS, one or more second SSs, and communicating, during the time window and based on the one or more second SSs, one or more physical channel signals, where the one or more physical channel signals include one or more uplink data signals, one or more downlink data signals, or one or more downlink control signals.

In some implementations, the time window spans a duration of a timer or transmission of the one or more first SSs, transmission of the WUS, transmission of the one or more second SSs, and communication of the one or more physical channel signals occur during the duration of the timer. In some implementations, the duration of the timer includes an active period of a C-DRX cycle.

In some implementations, the NE, the processor, and the method may further be configured to, capable of, or operable to transmit the one or more second SSs until expiration of the timer or transmit the one or more second SSs until an end of a C-DRX cycle corresponding to the WUS. In some implementations, the WUS includes a trigger that initiates the timer or transmission of the one or more second SSs or start timing symbols and/or slots about reception of the one or more second SSs, including an offset from the reception of the WUS or an offset from a start of the timer. In some implementations, the NE, the processor, and the method may further be configured to, capable of, or operable to determine that the NE has pending data to communicate with a UE, where transmission of the WUS is based on the determination that the NE has pending data to communicate with the UE.

In some implementations, the NE, the processor, and the method may further be configured to, capable of, or operable to transmit the one or more second SSs according to periodicity. In some implementations, the NE, the processor, and the method may further be configured to, capable of, or operable to transmit a respective second SS of the one or more second SSs prior to communication of the one or more physical channel signals. In some implementations, the NE, the processor, and the method may further be configured to, capable of, or operable to transmit multiple SSBs according to a periodicity, where the periodicity is based on a transmission rate of the WUS.

### BRIEF DESCRIPTION OF THE DRAWINGS

FIG. 1 illustrates an example of a wireless communications system in accordance with aspects of the present disclosure.

FIG. 2 illustrates an example of a wireless communications system in accordance with aspects of the present disclosure.

FIGS. 3A and 3B illustrate examples of communication timelines in accordance with aspects of the present disclosure.

FIG. 4 illustrates an example of a communication timeline in accordance with aspects of the present disclosure.

FIG. 5 illustrates an example of a communication timeline in accordance with aspects of the present disclosure.

FIG. 6 illustrates an example of a process flow in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates an example of a flowchart of a method performed by a UE in accordance with aspects of the present disclosure.

FIG. 11 illustrates an example of a flowchart of a method performed by an NE in accordance with aspects of the present disclosure.

### DETAILED DESCRIPTION

In a wireless communications system, an NE (e.g., a base station) may transmit common channel clusters to a UE. An example of common channel clusters may be SSBs which enable the UE to synchronize with the NE. In a downlink transmission and between common channel clusters, the NE may transmit one or more WUSs to the UE. The one or more WUSs may indicate for the UE to monitor, transmit, or receive one or more physical channel signals (e.g., physical uplink data signals, physical downlink control signals, or physical downlink data signals) during a specified duration. For network savings, the NE may transmit the common channel clusters at a relaxed periodicity (e.g., 160 ms). However, transmitting the common channel clusters at the relaxed periodicity may result in an accumulation of carrier frequency offset (CFO) and/or carrier timing offset (CTO) prior to communication of the one or more WUSs as well as the one or more physical channel signals which may decrease a reliability of the one or more WUSs and the one or more physical channel signals.

According to implementations described herein, the NE may provide additional SSs to correct any CFO and/or CTO accumulated between common channel clusters. The NE may detect that the NE has pending data for the UE, and generate a WUS. Further, the NE may transmit one or more first SS and thereafter, transmit the WUS. In some examples, the UE may utilize the one or more first SSs to correct any accumulated CFO and/or CTO prior to reception of the WUS. Upon receiving the WUS, the NE may transmit, during a time window that follows transmission of the WUS, one or more second SSs. Further, the UE may monitor, transmit, or receive one or more physical channel signals during the time window. In some examples, the NE may transmit a second SS of the one or more second SSs prior to communicating (e.g., transmitting or receiving) the one or more physical channel signals such that the UE may correct any accumulated CFO and/or CTO prior to communication the one or more physical channel signals.

It should be understood that various terms may be used interchangeably with “communicating,” such as “signaling,” “transmitting,” “receiving,” “outputting,” “forwarding,” “relaying,” “retrieving,” “obtaining,” and so forth.

By performing the techniques described, the wireless communications system provides a mechanism to correct CFO or CTO accumulated between transmission of common channel clusters (e.g., SSBs) which may increase a reliability of signals (e.g., WUSs or physical channel) communicated between transmission of common channel clusters.

Aspects of the present disclosure are described in the context of a wireless communications system. Additional aspects of the present disclosure are described in the context of component diagrams, process flows, method flows, etc. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

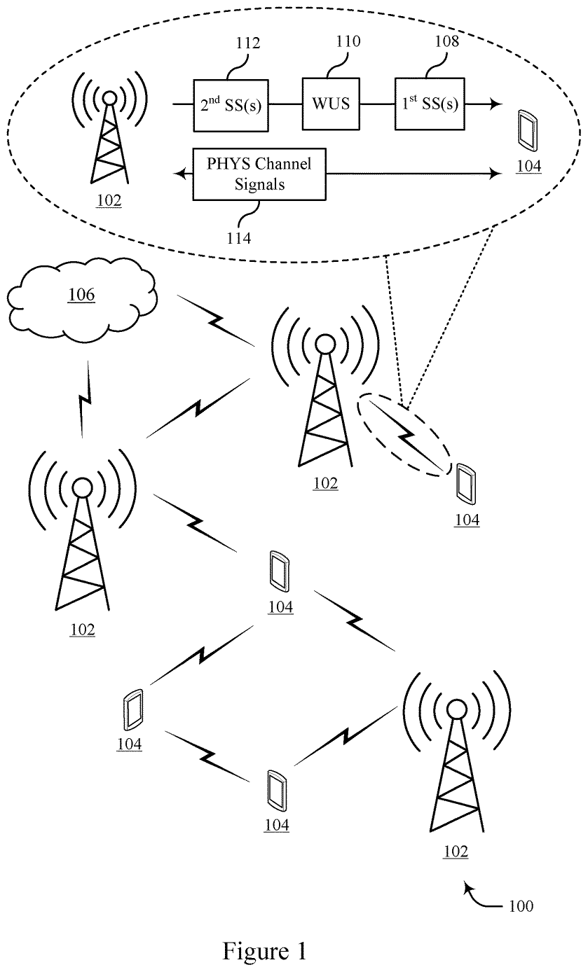

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1, μ=2,μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The NE 102 may transmit common channel clusters to a UE 104. An example of a common channel cluster may include one or more SSBs. SSBs may enable the UE 104 to recognize the NE 102 and synchronize to the NE 102. In some examples, the NE 102 may transmit the common channel clusters at a relaxed periodicity (e.g., 160 ms). Although transmitting the common channel cluster at the relaxed periodicity may provide network energy savings, an extended time gap between two common channel clusters may result in an accumulation of CFO and CTO between the two common channel clusters which may negatively impact physical channel signals communicated between the two common channel clusters.

Further, the wireless communications system 100 may support C-DRX. During C-DRX, the UE 104 may periodically enter a sleep state during which physical channel signals (e.g., PDCCH) need not be monitored. In order to monitor for the physical channel signals, the UE 104 may wake up and stay awake for a duration of time before entering the sleep state again. A time that the UE 104 monitors for the physical channel signals may be referred to as an active state or a DRX ON period, whereas a time that the UE 104 does not monitor for the physical channel signals may be referred to as a sleep state or a DRX OFF period. A long DRX cycle may include one DRX ON period and one DRX OFF period. The DRX ON period (or On Duration or active period) may be defined in terms of ms. The NE 102 may configure the UE 104 with aspects of the long DRX cycle via radio resource control (RRC). For example, the NE 102 may control a start location of the long DRX cycle using an RRC parameter drx-LongCycleStartOffset. Additionally, the NE 102 may configure a start of the DRX ON period at a slot level of granularity within a subframe using an RRC parameter drx-SlotOffset.

Once a long DRX cycle starts, the UE 104 may stay active for a duration of an On Duration timer (e.g., drx-onDurationTimer) and if the UE 104 does not detect PDCCH before expiration of the On Duration timer, the UE 104 may enter the sleep state until a start of the next On Duration timer. If the UE 104 detects PDCCH before expiration of the timer, the UE 104 will most likely be scheduled in the future. Thus, the NE 102 may configure the UE 104 with a DRX inactivity timer (e.g., drx-InactivityTimer). The UE 104 may start the DRX inactivity timer each time PDCCH indicates an uplink or downlink transmission, and the UE 104 may stay in the active state and keep monitoring for PDCCH until expiry of the DRX inactivity timer. The wireless communications system 100 may also support a WUS. If there is data for the UE 104, the NE 102 may transmit a WUS that indicates for the UE 104 to wake up (e.g., transition from the sleep state to the active state) and in response, the UE 104 may monitor for the physical channel signals (e.g., during the DRX ON period). Alternatively, if there is no data for the UE 104, the NE 102 may transmit a WUS to the UE 104 that indicates for the UE 104 to not wake up (e.g., remain in the sleep state) and the UE 104 may not monitor for physical channel signals (e.g., even during the DRX ON period).

In some examples, the UE 104 may perform one or more long DRX cycles in a time gap between two common channel clusters (or two SSBs). If a periodicity of the common channel cluster includes a relaxed periodicity (e.g., 160 ms), the WUS as well as the corresponding physical channel signals may experience an accumulation of CFO and CTO which may negatively impact a reliability of the WUS and the physical channel signals. Therefore, it may be beneficial to introduce additional SSs to correct the accumulation of CFO and CTO prior to the communication of the WUS as well as prior to the communication of the physical channel signals.

According to implementations, one or more of the NEs 102 and the UEs 104 are operable to implement various aspects of the techniques described with reference to the present disclosure. For example, a UE 104 may receive one or more first SSs 108, receive a WUS 110 based on the one or more first SSs 108, receive, during a time window that occurs after reception of the WUS 110, one or more second SSs 112, and communicate, during the time window and based on the one or more second SSs 112, one or more physical channel signals 114, where the one or more physical channel signals 114 include one or more uplink data signals, one or more downlink data signals, or one or more downlink control signals. An NE 102 (e.g., a base station, gNB) may transmit one or more first SSs 108, transmit a WUS 110 based on the one or more first SSs 108, transmit, during a time window that occurs after transmission of the WUS 110, one or more second SSs 112, and communicate, during the time window and based on the one or more second SSs 112, one or more physical channel signals 114, where the one or more physical channel signals 114 include one or more uplink data signals, one or more downlink data signals, or one or more downlink control signals.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

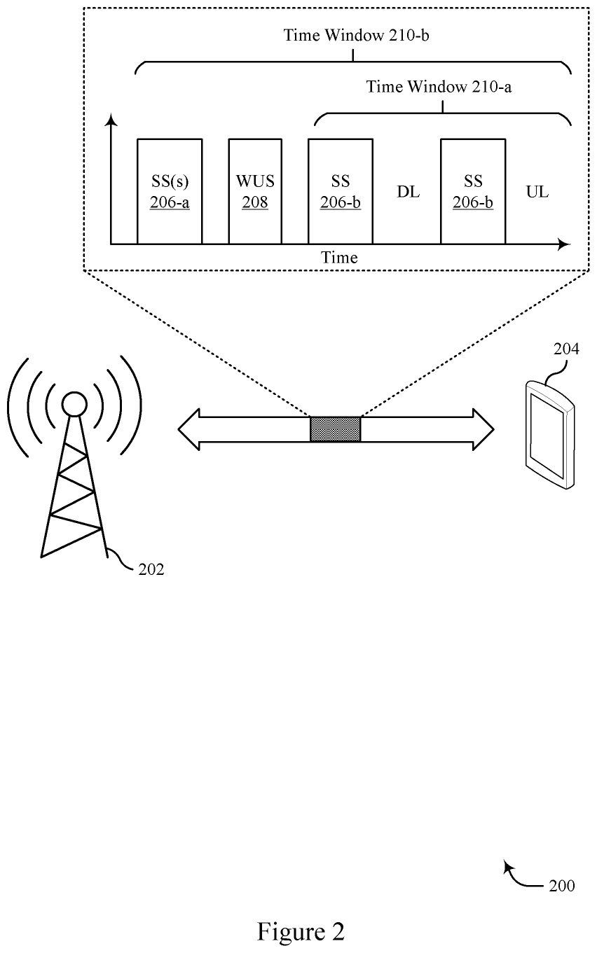

FIG. 2 illustrates an example of a wireless communications system 200 in accordance with aspects of the present disclosure. In some examples, the wireless communications system 200 may include aspects of the wireless communications system 100. For example, the wireless communications system 200 may include an NE 202 and a UE 204 which may be examples of the NE 102 and the UE 104, respectively, as described with reference to FIG. 1.

In some examples, the UE 204 may be in sleep state. While in the sleep state, the UE 204 may not monitor, receive, or transmit physical channel signals (e.g., PDCCH, physical downlink shared channel (PDSCH), or physical uplink shared channel (PUSCH)). Sometime after the UE 204 enters the sleep state, the NE 202 may determine that the NE 202 has pending data to communicate with the UE 204 and generate a WUS 208. Prior to transmitting the WUS 208, the NE 202 may transmit one or more SSs 206-a to the UE 204. Using the one or more SSs 206-a, the UE 204 may correct any CFO or CTO accumulated while the UE 204 was in the sleep state. The UE 204 may monitor for the one or more SSs 206-a at one or more candidate resources allocated for the one or more SSs 206-a and in some examples, the one or more SSs 206-a may include multiple SSs 206-a that are bundled as a consecutive burst. During a WUS monitoring occasion that occurs after the candidate resources, the UE 204 may monitor for and receive the WUS 208 from the NE 202.

Upon receiving the WUS 208, the UE 204 may monitor, receive, or transmit one or more physical channel signals during a time window 210-a. Further, during the time window, the UE 204 may receive one or more SSs 206-b. In some examples, the UE 204 may receive an SS 206-b prior to receiving or transmitting the one or more physical channel signals. The SSs 206-b may enable the UE 204 to correct fine CFO or CTO prior to receiving or transmitting the one or more physical channel signals. For example, as shown in FIG. 1, the UE 204 may receive an SS 206-b prior to reception of a physical downlink channel signal (e.g., PDCCH or PDSCH) and another SS 206-b prior to transmission of a physical uplink channel signal (e.g., PDSCH). In some examples, the NE 202 may transmit the one or more SSs 206-b at some periodicity (e.g., every 40 ms).

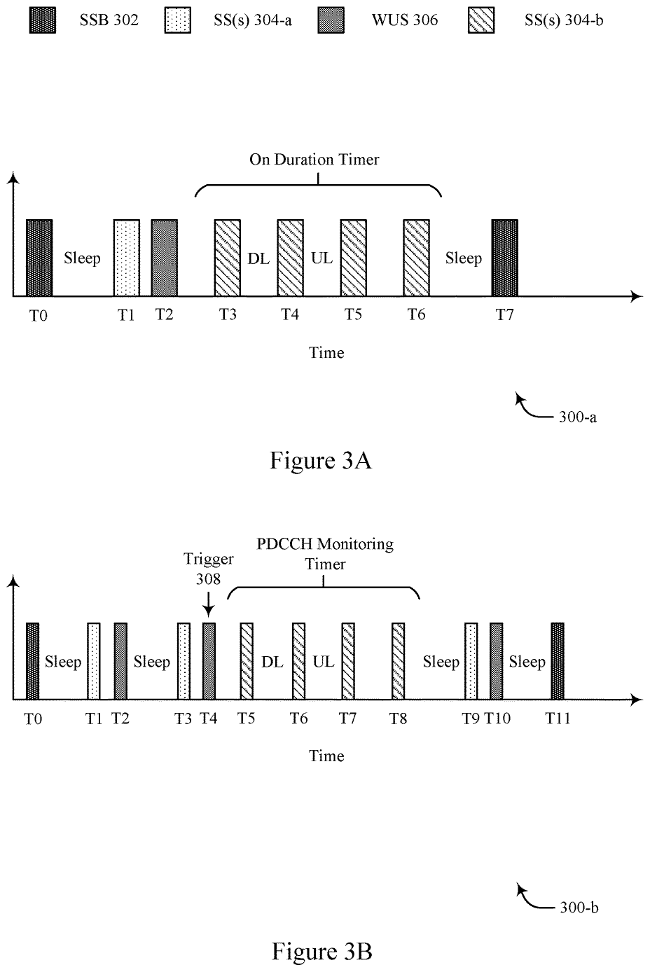

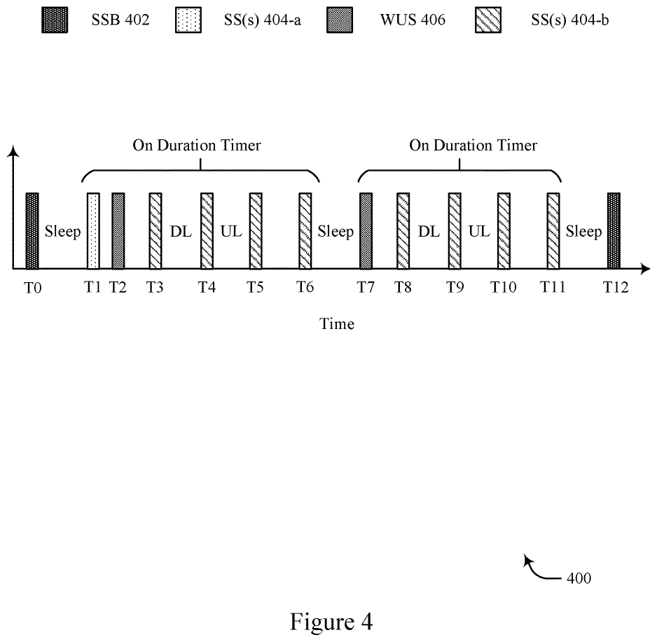

According to a first implementation, the UE 204 may initiate a timer upon reception of the WUS 208 and a duration of the timer may be equal to or include the time window 210-a. According to a second implementation, the UE 204 may initiate the timer prior to reception of the one or more SSs 206-a and a duration of the timer may be equal to or include the time window 210-b. The timer may be an example of an On Duration timer or a PDCCH monitoring timer. As described in FIG. 1, the On Duration timer may define an active time of a C-DRX cycle in which the UE 204 is awake and monitoring for physical channel signals. Upon expiration of the On-Duration timer, the UE 204 may transition from the awake state to the sleep state for a remainder of the C-DRX cycle. In some examples, the NE 202 may transmit the one or more SSs 206-b until expiration of the timer or until an end of the C-DRX cycle. Further, the NE 202 may determine a periodicity or a density of the one or more SSs 206-b based on a mobility of the UE 204 or the duration of the timer. If the NE 202 determines that the NE 202 does not have pending data to communicate with the UE 204, the NE 202 may not transmit the WUS 208 to the UE 204. Alternatively, the NE 202 may transmit the WUS 208 to the UE 204 that does not include a trigger to initiate the timer, and in response, the UE 204 may not initiate the timer and therefore, not receive the one or more SSs 206-b from the NE 202. Details related to the first implementation are described in FIGS. 3A and 3B and details related to the second implementation are described in FIG. 4.

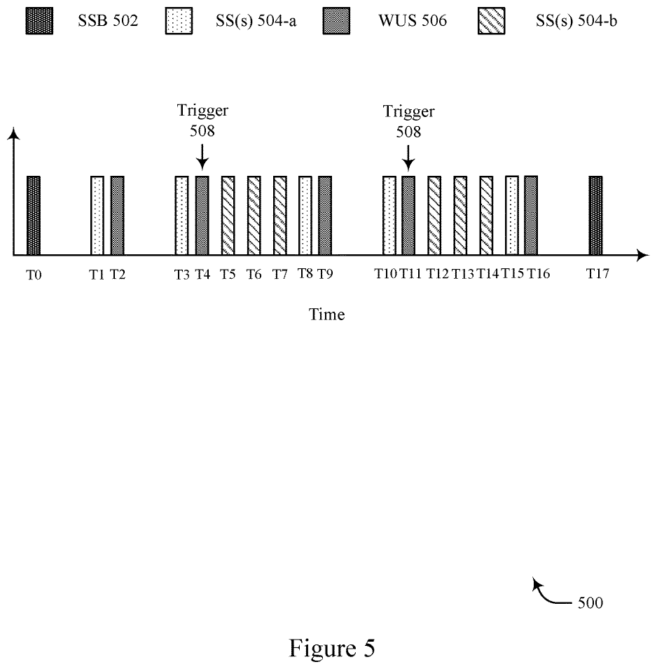

According to a third implementation, the WUS 208 may trigger physical channel monitoring without C-DRX configuration. The UE 204 may identify WUS monitoring occasions and receive the one or more SSs 206-a from the NE 202 prior to the WUS monitoring occasion. If the NE 202 has pending data to communicate to the UE 204, the NE 202 may transmit, to the UE 204 and during the WUS monitoring occasion, the WUS 208 that includes a trigger that indicates activation of a physical channel monitoring occasion or start timing symbols and/or slots about reception of the one or more SSs 206-b, including an offset from the reception of the WUS 208 or an offset from a start of a timer. The physical channel monitoring occasion may correspond to the time window 210-a. Further, the NE 202 may transmit, during the physical channel monitoring occasion, the one or more SSs 206-b to the UE 204 until an end of the physical channel monitoring occasion. Details related to the third implementation are described in FIG. 5. In some examples, the SSs 206 (e.g., SS 206-a and SS 206-b) may be examples of SSBs.

In some examples, the SS 206-b present during the On Duration period or the PDCCH monitoring period may be semi-persistent which starts from the beginning of On Duration period or PDCCH monitoring period and ends with expiry of the timer. Further, the SS 206-b may be present when UE 204 starts an inactivity timer and until the end of the inactivity timer. The SS 206-b may be transmitted only above a certain configurable offset from the SS 206-a, another periodic SS or any tracking reference signal (TRS) to prevent frequent transmission of the SS 206-b.

In some examples, the UE 204 may monitor for one or more WUSs 208 between reception of common channel clusters. The common clusters may include SSBs. As an example, the UE 204 may receive a first SSB prior to reception of the WUS 208 and a second SSB after reception of the WUS 208. In some examples, the NE 202 may transmit the SSBs based on an event trigger (e.g., on-demand or according to a dynamic periodicity). In some examples, the event trigger may indicate start timing symbols and/or slots about reception of the SSBs, including an offset from the reception of the WUS 208 or an offset from a start of a timer. An SSB measurement time period may be known as SMTC. Using other methods, a measurement period for cell detection is defined by Equation 1, where M_{period} is a measurement period (e.g., carrier specific), T_{SMTC} is a SMTC periodicity (e.g., 5, 10, 20, 40, 80, or 160 ms), P is a scaling factor for DRX (e.g., depends on the DRX cycle), and Sₘₑₐₛᵤᵣₑ is a scaling factor for measurement gaps.

Tₘₑₐₛᵤᵣₑ=Max(M_{period}, T_{SMTC})×P×Sₘₑₐₛᵤᵣₑ (1)

With event-triggered SMTC, T_{SMTC} is not a fixed value. Instead, T_{SMTC} is a dynamic value and may be event-driven. That is, T_{SMTC} may become stochastic and depend on a WUS trigger rate which may depend on downlink traffic arrival. In this case, Equation 1 will need either a worst-case bound on inter-measurement gap or a statistical guarantee (e.g., at least N within Tₘₐₓ). P may account for the fraction of time the UE 204 is awake. With event-triggered SMTC, the UE may be awake less often than DRX may imply. Further, with event-triggered SMTC, a number of SSB or SS206 samples available for L3 filtering may be random (e.g., as opposed to deterministic).

In some examples, the network may provide a minimum SMTC measurement rate even when there is no downlink data. Options for this may include a fallback periodic SMTC (e.g., if there is no WUS trigger within Tₘₐₓ, the UE 204 autonomously performs one SMTC measurement), a mandatory minimum WUS rate for SMTC (e.g., NE 202 transmits periodic WUS triggers at a minimum rate purely for measurement purposes, even without downlink data), or a hybrid (e.g., event-triggered SMTC plus periodic fallback with relaxed periodicity).

Using other methods, L3 filtering may assume regular sample spacing. With event-triggered SMTC, samples may arrive at irregular intervals, temporal correlations between samples may vary, a filter coefficient (e.g., α in Fₙ=(1−α)·F₍ₙ₋₁₎+α·Mₙ) may require adaption, and time-weighted filtering may be supported (e.g., as opposed to sample-weighted filtering). Using other methods, cell search may require acquiring energy across multiple SSB occasions. With event-triggered SMTC, coherent combining across measurement occasions may become harder if inter-occasion gap is variable, cell detection delay becomes probabilistic (e.g., as opposed to deterministic), and T_{detect_intra} and T_{detect_inter} may require revisions. In some examples, RLM and BFD timers may be periodic with specific evaluation periods (e.g., T_{_|RLM}). Using other methods, an evaluation period for RLM may assume periodic measurement. With event-triggered SMTC, the evaluation periods may be redefined. For example, the network may define a maximum allowable gap between SMTC occasions for RLM or BFD independent of WUS.

With event-triggered SMTC, SSs 206 from a serving cell may aid with serving cell measurement, but neighbor cell's SSBs may still arrive at their own SMTC periodicity. Further, if the UE 204 is awake during event-triggered windows, the UE 204 may miss neighbor cell's SSBs. Thus, the event-triggered SMTC windows may be aligned with neighbor cell's SSB timing. For event-triggered SMTC, Equation 1 may be redefined as Equation 2, where T_{max_inter_trigger} is a maximum allowed gap between WUS-triggered measurements (e.g., RRC configured), TSMTC_fallback is a fallback SMTC period if no WUS within Tₘₐₓ, and KET is an event-triggered scaling factor (e.g., accounts for variable sample spacing). A number of sample for L3 filtering with an evaluation window may be Nsamples≥Nmin within Tevaluate (e.g., as opposed to assuming a fixed periodicity).

T_{measure_ET}=Max(T_{max_inter_trigger}, T_{SMTC_fallback})×K_{ET}×Sₘₑₐₛᵤᵣₑ (2)

In intra-frequency, neighbor cells may operate on a same center frequency and subcarrier spacing as a serving cell. The UE 204 may assume that the neighbor's SSBs are roughly time-aligned with the serving cells. The UE 204 may use a same SMTC window configured for the serving cell to look for the neighbor's SSBs. In some examples, the UE 204 may not retune its radio. While the UE 204 is receiving the SSB from the serving cell, it may simultaneously listen for the physical cell IDs (PCI) of the neighboring cells that appear in the same window. In some examples, the intra-frequency measurements may be periodic.

In inter-frequency, the neighbor cells operate on a different frequency. Because the UE 204 may have one primary radio chain, the UE 204 may not have a capability to listen to two frequencies at once. Thus, the UE 205 may leave the serving frequency, retune to a new frequency, measure, and then tune back to the serving frequency. In some examples, the network provides a separate SMTC configuration for each inter-frequency carrier. The SMTC configuration may indicate an SSB window for different frequencies and offsets. To prevent data loss while the UE 204 is away from the serving frequency, the network may configure a measurement gap and the SMTC window for the inter-frequency neighbor may fit within the measurement gap. In some examples, if the serving cell frequency is strong, the inter-frequency may be on-demand or event-triggered inter-frequency measurements. The network may send WUS when a serving cell signal drops below some configured threshold triggering the measurement map and the UE 204 may use the SMTC window for the inter-frequency measurements.

FIGS. 3A and 3B illustrate examples of a communication timeline 300-a and a communication timeline 300-b in accordance with aspects of the present disclosure. In some examples, the communication timeline 300-a and the communication timeline 300-b may be implemented by aspects of the communications system 100 or the communications system 200. For example, the communication timeline 300-a and the communication timeline 300-b may be implemented by the NE 102, the UE 104, the NE 202, or the UE 204 as described with reference to FIGS. 1 and 2.

With reference to FIG. 3A, the UE may receive an SSB 302 from an NE at T0. Starting from at least T0, the UE may be in a sleep state. While in the sleep state, the UE may not monitor, transmit, or receive physical channel signals (e.g., PDCCH, PDSCH, or PUSCH). The NE may determine that the NE has pending data for the UE and generate a WUS 306. At T1, the NE may transmit one or more SSs 304-a to the UE. Using the one or more SSs 304-a, the UE may correct any CFO or CTO accumulated while the UE was in the sleep state (e.g., from T0 to T1). At T2, the UE may receive the WUS 306 from the NE. Upon receiving the WUS 306, the UE may initiate an On Duration timer. The On Duration timer may define a duration that the UE maintains an active state during a DRX cycle (e.g., a long D-DRX cycle). Upon initiating the On Duration timer, the UE may transition from the sleep state to the active state. While in the active state, the UE may monitor, receive, or transmit one or more physical channel signals for the duration of the On Duration timer.

While the UE monitors, receives, or transmits the one or more physical channel signals during the On Duration timer, the UE may also receive one or more SSs 304-b. For example, the UE may receive an SS 304-b from the NE at T3, T4, T5, and T6. The one or more SSs 304-b may enable the UE to correct CFO or CTO of the one or more physical channel signals. In some examples, the NE may transmit an SS 304-b prior PDCCH and prior to PDSCH/PUSCH scheduled by the PDCCH for fine CTO and CTO correction. Additionally, or alternatively, the NE may transmit the one or more SSs 304-b according to a periodicity. The NE may determine the periodicity based on a mobility of the UE or the duration of the On-Duration timer. After T6, the On Duration timer may expire and the UE may re-enter the sleep state. At T7, the UE may receive another SSB 302. A duration between the T0 and T7 may be based on an SSB periodicity. The UE or the NE may determine the SSB periodicity based on a reception rate of the WUS 306 as described in FIG. 2.

With reference to FIG. 3B, the UE may receive the SSB 302 from an NE at T0. Starting from at least T0, the UE may be in the sleep state. While in the sleep state, the UE may not monitor, transmit, or receive physical channel signals (e.g., PDCCH, PDSCH, or PUSCH). The NE may determine that the NE does not have pending data for the UE and generate the WUS 306 that does not include a trigger 308 that indicates activation of a PDCCH monitoring timer (e.g., different than the On Duration timer). In some examples, the PDCCH monitoring timer may not correspond to the DRX cycle. For example, the PDCCH monitoring timer may define a duration that the UE maintains an active state which may be outside of the active period of the DRX cycle. At T1, the NE may transmit the one or more SSs 304-a to the UE. Using the one or more SSs 304-a, the UE may correct any CFO or CTO accumulated while the UE was in the sleep mode (e.g., from T0 to T1). At T2, the UE may receive the WUS 306 that does not include the trigger 308 from the NE. Because the WUS 306 does not include the trigger 308, the UE may not monitor, receive, or transmit physical channel signals after reception of the WUS 306 at T2 and remain in the sleep state.

After T2, the NE may determine that the NE has pending data for the UE and generate the WUS 306 that includes the trigger 308 that indicates activation of the PDCCH monitoring timer. At T3, the NE may transmit the one or more SSs 304-a to the UE. At T4, the UE may receive the WUS 306 that includes the trigger 308 from the NE. Because the WUS 306 includes the trigger 308, the UE may initiate (or activate) the PDCCH monitoring timer. Upon initiating the PDCCH monitoring timer, the UE may transition from the sleep state to the active state. While in the active state, the UE may monitor, receive, or transmit one or more physical channel signals for the duration of the PDCCH monitoring timer.

While the UE monitors, receives, or transmits the one or more physical channel signals during the PDCCH monitoring timer, the UE may also receive the one or more SSs 304-b from the NE. For example, the UE may receive the SS 304-b from the NE at T5, T6, T7, and T8. The one or more SSs 304-b may enable the UE to correct CFO or CTO of the one or more physical channel signals. In some examples, the NE may transmit the SS 304-b prior to PDCCH and prior to PDSCH/PUSCH scheduled by the PDCCH for fine CTO and CTO correction. Additionally, or alternatively, the NE may transmit the SSs 304-b according to a periodicity. The NE may determine the periodicity based on a mobility of the UE or the duration of the PDCCH monitoring timer. After T8, the PDCCH monitoring timer may expire and the UE may re-enter the sleep state.

Further, after T8, the NE may determine that the NE does not have pending data for the UE and generate the WUS 306 that does not include the trigger 308. At T9, the NE may transmit the one or more SSs 304-a to the UE. At T10, the UE may receive the WUS 306 that does not include the trigger 308 from the NE. Because the WUS 306 does not include the trigger 308, the UE does not monitor, receive, or transmit physical channel signals after reception of the WUS 306 at T10. At T11, the UE may receive another SSB 302. A duration between the T0 and T11 may be based on an SSB periodicity. The UE or the NE may determine the SSB periodicity based on a reception rate of the WUS 306 as described in FIG. 2.

FIG. 4 illustrates an example of a communication timeline 400 in accordance with aspects of the present disclosure. In some examples, the communication timeline 400 may be implemented by aspects of the wireless communications system 100 or the wireless communications system 200. For example, the communication timeline 400 may be implemented by the NE 102, the UE 104, the NE 202, or the UE 204 as described with reference to FIGS. 1 and 2.

A UE may receive an SSB 402 from an NE at T0. Starting from at least T0, the UE may be in a sleep state. While in the sleep state, the UE may not monitor, transmit, or receive physical channel signals (e.g., PDCCH, PDSCH, or PUSCH). After T0, the NE may determine that the NE has pending data for the UE and generate a WUS 406. Further, after T0, the UE may initiate an On Duration timer. The On Duration timer may define a duration that the UE maintains an active state during a DRX cycle (e.g., a long C-DRX cycle). While in the active state, the UE may monitor, receive, or transmit one or more physical channel signals for the duration of the On Duration timer. At T1 and during the duration of the On Duration timer, the NE may transmit one or more SSs 404-a to the UE. Using the one or more SSs 404-a, the UE may correct any CFO or CTO accumulated while the UE was in the sleep state (e.g., from T0 to T1). At T2 and during the duration of the On Duration timer, the UE may receive the WUS 406 from the NE. Upon receiving the WUS 406, the UE may start monitoring, transmitting, or receiving the one or more physical channel signals during the duration of the On Duration timer.

While the UE monitors, receives, or transmits the one or more physical channel signals during the duration of the On Duration timer, the UE may also receive one or more SSs 404-b. For example, the UE may receive an SS 404-b from the NE at T3, T4, T5, and T6. The SSs 404-b may enable the UE to correct CFO or CTO of the one or more physical channel signals. In some examples, the NE may transmit the SS 404-b prior to PDCCH and prior to PDSCH/PUSCH scheduled by the PDCCH for fine CFO and CTO correction. Additionally, or alternatively, the NE may transmit the one or more SSs 404-b according to a periodicity. The NE may determine the periodicity based on a mobility of the UE or the duration of the On Duration timer. After T6, the On Duration timer may expire and the UE may re-enter the sleep state. Further, after T6, the NE may determine that the NE has pending data for the UE and generate another WUS 406. Moreover, after T6 and prior to T7, the UE may initiate the On Duration timer. At T7 and during the duration of the On Duration timer, the UE may receive the WUS 406 from the NE. In this case, the UE may not receive the one or more SSs 404-a prior to receiving the WUS 406 at T7. In some examples, the UE may receive the one or more SSs 404-a prior to receiving the WUS 406 if some condition is met (e.g., if a duration between transmission of an SS (e.g., SS 404-a or SS 404-b) and the WUS 406 is less than a threshold). Upon receiving the WUS 406, the UE may start monitoring, transmitting, or receiving the one or more physical channel signals during the duration of the On Duration timer.

While the UE monitors, receives, or transmits physical channel signals during the duration of the On Duration Timer, the UE may also receive the one or more SSs 404-b. For example, the UE may receive the SS 404-b from the NE at T8, T9, T10, and T11. After T11, the On Duration timer may expire and the UE may re-enter the sleep state. At T12, the UE may receive another SSB 402. A duration between the T0 and T12 may be based on an SSB periodicity. The UE or the NE may determine the SSB periodicity based on a reception rate of the WUS 406 as described in FIG. 2.

FIG. 5 illustrates an example of a communication timeline 500 in accordance with aspects of the present disclosure. In some examples, the communication timeline 500 may be implemented by aspects of the wireless communications system 100 or the wireless communications system 200. For example, the communication timeline 500 may be implemented by the NE 102, the UE 104, the NE 202, or the UE 204 as described with reference to FIGS. 1 and 2.

In the example of FIG. 5, a UE is not configured with C-DRX mode. Instead, the UE is configured to monitor a WUS 506 and physical channel signals via continuous or duty-cycled monitoring. At T0, the UE may receive an SSB 502 from an NE. After T0, the NE may determine that the NE does not have pending data for the UE and generate the WUS 506 that does not include a trigger 508 that indicates to monitor for physical channel signal during a PDCCH monitoring occasion. At T1, the NE may transmit one or more SSs 504-a to the UE. Using the one or more SSs 504-a, the UE may correct any accumulated CFO or CTO. At T2, the UE may receive the WUS 506 that does not include the trigger 508 from the NE. Because the WUS 506 does not include the trigger 508, the UE does not monitor, receive, or transmit physical channel signals after reception of the WUS 506.

After T2, the NE may determine that the NE has pending data for the UE and generate another WUS 506 that includes the trigger 508 that indicates to monitor for physical channel signals. At T3, the NE may transmit the one or more SSs 504-a to the UE. At T4, the UE may receive the WUS 506 that includes the trigger 508 from the NE. Because the WUS 506 includes the trigger 508, the UE may monitor for physical channel signals during a PDCCH monitoring occasion that occurs after the WUS 506.

While the UE monitors for the physical channel signals, the UE may also receive SSs 504-b from the NE during the PDCCH monitoring occasion. For example, the UE may receive the SS 504-b from the NE at T5, T6, and T7. The SSs 504-b may enable the UE to correct CFO or CTO of the physical channel signals. In some examples, the NE may transmit the SS 504-b prior to PDCCH and prior to PDSCH/PUSCH scheduled by the PDCCH for fine CTO and CTO correction. Additionally, or alternatively, the NE may transmit the SSs 504-b according to a periodicity. The NE may determine the periodicity based on a mobility of the UE or the duration of the PDCCH monitoring occasion.

After T7, the NE may determine that the NE does not have pending data for the UE and generate the WUS 506 that does not include the trigger 508. At T8, the NE may transmit the one or more SSs 504-a to the UE. At T9, the UE may receive the WUS 506 that does not include the trigger 508 from the NE. Because the WUS 506 does not include the trigger 508, the UE does not monitor, receive, or transmit physical channel signals after reception of the WUS 506. After T9, the NE may determine that the NE has pending data for the UE and generate a WUS 506 that includes the trigger 508. At T10, the NE may transmit the one or more SSs 504-a to the UE. At T11, the UE may receive the WUS 506 that includes the trigger 508 from the NE. Because the WUS 506 includes the trigger 508, the UE may monitor for physical channel signals during a PDCCH monitoring occasion that occurs after the WUS 506.

While the UE monitors for the physical channel signals, the UE may also receive SSs 504-b from the NE during the PDCCH monitoring occasion. For example, the UE may receive the SSs 504-b from the NE at T12, T13, and 14. After T14, the NE may determine that the NE does not have pending data for the UE and generate the WUS 506 that does not include the trigger 508. At T15, the NE may transmit the one or more SSs 504-a to the UE. At T16, the UE may receive the WUS 506 that does not include the trigger 508 from the NE. Because the WUS 506 does not include the trigger 508, the UE does not monitor, receive, or transmit physical channel signals after reception of the WUS 506 at T16. At T17, the UE may receive another SSB 502. A duration between the T0 and T17 may be based on an SSB periodicity. The UE or the NE may determine the SSB periodicity based on a reception rate of the WUS 506 as described in FIG. 2.

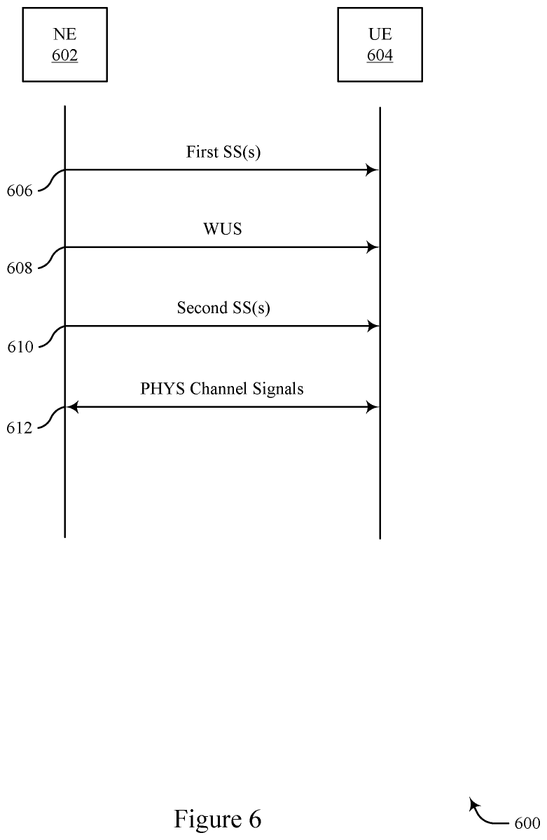

FIG. 6 illustrates an example of a process flow 600 in accordance with aspects of the present disclosure. In some examples, the process flow 600 may be implemented by aspects of the wireless communications system 100 and the wireless communications system 200. For example, the process flow 600 may be implemented by an NE 602 or a UE 604 which may be examples of the NE 102, the UE 104, the NE 202, or the UE 204 as described with reference to FIGS. 1 and 2.

At 606, the UE 604 may receive one or more first SSs from the NE 602.

At 608, the UE 604 may receive a WUS from the NE 602 based on the one or more first SSs. In one implementation, the UE 604 may initiate a timer based on the WUS. In another implementation, the UE 604 may initiate the timer prior to reception of the one or more first SSs. A duration of the timer may include an active period of a C-DRX cycle.

At 610, the UE 604 may receive, during a time window that occurs after reception of the WUS, one or more second SSs from the NE 602. In one implementation, the UE 604 may receive the one or more second SSs until expiration of the timer. In another implementation, the UE 604 may receive the one or more second SSs until an end of the C-DRX cycle corresponding to the WUS. In some examples, the UE 604 may receive the one or more second SSs according to a periodicity. Further, the UE 604 may receive a respective second SS of the one or more second SSs prior to communication of the one or more physical channel signals.

At 612, the UE 604 may communicate, during the time window and based on the one or more second SSs, one or more physical channel signals with the NE 602. In some examples, the one or more physical channel signals may include one or more uplink data signals, one or more downlink data signals, or one or more downlink control signals.

In some examples, the UE 604 may receive multiple SSBs according to a periodicity, where the periodicity is based on a reception rate of the WUS.

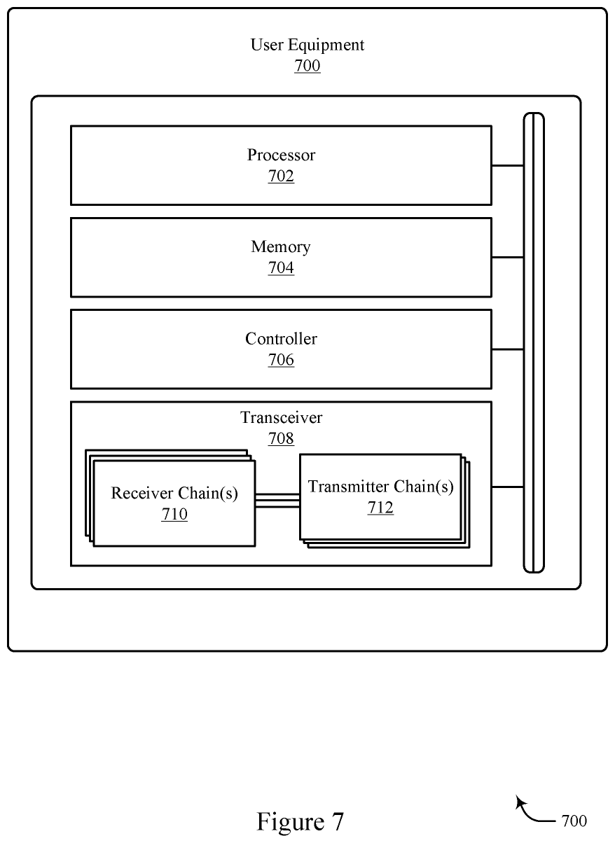

FIG. 7 illustrates an example of a UE 700 in accordance with aspects of the present disclosure. In some examples, the UE 700 may be an example of a UE as described herein. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving one or more first SSs, receiving a WUS based on the one or more first SSs, receiving, during a time window that occurs after reception of the WUS, one or more second SSs, and communicating, during the time window and based on the one or more second SSs, one or more physical channel signals, where the one or more physical channel signals include one or more uplink data signals, one or more downlink data signals, or one or more downlink control signals.

Additionally, or alternatively, the UE 700 may support at least one memory (e.g., the memory 704) and at least one processor (e.g., the processor 702) coupled with the at least one memory and configured to cause the UE to receive one or more first SSs, receive a WUS based on the one or more first SSs, receive, during a time window that occurs after reception of the WUS, one or more second SSs, and communicate, during the time window and based on the one or more second SSs, one or more physical channel signals, where the one or more physical channel signals include one or more uplink data signals, one or more downlink data signals, or one or more downlink control signals.

Additionally, the UE 700 may be configured to support any one or combination of the at least one processor configured to cause the UE 700 to initiate a timer based on the WUS, where the time window spans a duration of the timer or initiate the timer prior to reception of the one or more first SSs. Additionally, the UE 700 may be configured to support any one or combination of the at least one processor configured to cause the UE 700 to receive the one or more second SSs until expiration of the timer or receive the one or more second SSs until an end of a C-DRX cycle corresponding to the WUS.

Additionally, the UE 700 may be configured to support any one or combination of the at least one processor configured to cause the UE 700 to receive the one or more second SSs according to periodicity. Additionally, the UE 700 may be configured to support any one or combination of the at least one processor configured to cause the UE 700 to receive a respective second SS of the one or more second SSs prior to communication of the one or more physical channel signals. Additionally, the UE 700 may be configured to support any one or combination of the at least one processor configured to cause the UE 700 to receive multiple SSBs according to a periodicity, where the periodicity is based on a reception rate of the WUS.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

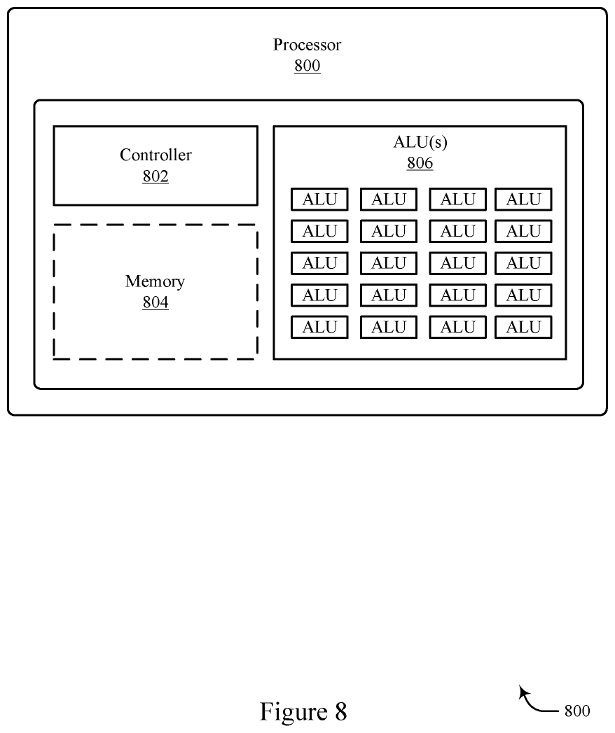

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to receive one or more first SSs, receive a WUS based on the one or more first SSs, receive, during a time window that occurs after reception of the WUS, one or more second SSs, and communicate, during the time window and based on the one or more second SSs, one or more physical channel signals, where the one or more physical channel signals include one or more uplink data signals, one or more downlink data signals, or one or more downlink control signals.

Additionally, the processor 800 may be configured to or operable to support any one or combination of initiating a timer based on the WUS, where the time window spans a duration of the timer or initiating the timer prior to reception of the one or more first SSs. Additionally, the processor 800 may be configured to or operable to support any one or combination of receiving the one or more second SSs until expiration of the timer or receiving the one or more second SSs until an end of a C-DRX cycle corresponding to the WUS.

Additionally, the processor 800 may be configured to or operable to support any one or combination of receiving the one or more second SSs according to periodicity. Additionally, the processor 800 may be configured to or operable to support any one or combination of receiving a respective second SS of the one or more second SSs prior to communication of the one or more physical channel signals. Additionally, the processor 800 may be configured to or operable to support any one or combination of receiving multiple SSBs according to a periodicity, where the periodicity is based on a reception rate of the WUS.

Moreover, the processor 800 may be configured to or operable to support at least one controller (e.g., the controller 802) coupled with at least one memory (e.g., the memory 804) and configured to cause the processor to transmit one or more first SSs, transmit a WUS based on the one or more first SSs, transmit, during a time window that occurs after transmission of the WUS, one or more second SSs, and communicate, during the time window and based on the one or more second SSs, one or more physical channel signals, where the one or more physical channel signals include one or more uplink data signals, one or more downlink data signals, or one or more downlink control signals.

Additionally, the processor 800 may be configured to or operable to support any one or combination of transmitting the one or more second SSs until expiration of the timer or transmitting the one or more second SSs until an end of a C-DRX cycle corresponding to the WUS. Additionally, the processor 800 may be configured to or operable to support any one or combination of determining that the NE has pending data to communicate with a UE, where transmission of the WUS is based on the determination that the NE has pending data to communicate with the UE.

Additionally, the processor 800 may be configured to or operable to support any one or combination of transmitting the one or more second SSs according to periodicity. Additionally, the processor 800 may be configured to or operable to support any one or combination of transmitting a respective second SS of the one or more second SSs prior to communication of the one or more physical channel signals. Additionally, the processor 800 may be configured to or operable to support any one or combination of transmitting multiple SSBs according to a periodicity, where the periodicity is based on a transmission rate of the WUS.

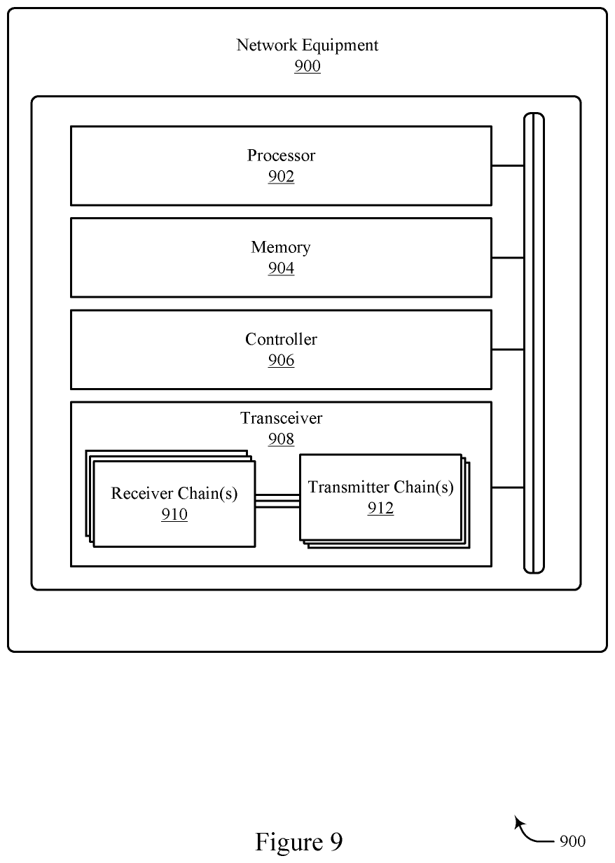

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting one or more first SSs, transmitting a WUS based on the one or more first SSs, transmitting, during a time window that occurs after transmission of the WUS, one or more second SSs, and communicating, during the time window and based on the one or more second SSs, one or more physical channel signals, where the one or more physical channel signals include one or more uplink data signals, one or more downlink data signals, or one or more downlink control signals.

Additionally, or alternatively, the NE 900 may support at least one memory (e.g., the memory 904) and at least one processor (e.g., the processor 902) coupled with the at least one memory and configured to cause the NE to transmit one or more first SSs, transmit a WUS based on the one or more first SSs, transmit, during a time window that occurs after transmission of the WUS, one or more second SSs, and communicate, during the time window and based on the one or more second SSs, one or more physical channel signals, where the one or more physical channel signals include one or more uplink data signals, one or more downlink data signals, or one or more downlink control signals.

Additionally, the NE 900 may be configured to support any one or combination of the at least one processor configured to cause the NE 900 to transmit the one or more second SSs until expiration of the timer or transmit the one or more second SSs until an end of a C-DRX cycle corresponding to the WUS. Additionally, the NE 900 may be configured to support any one or combination of the at least one processor configured to cause the NE 900 to determine that the NE has pending data to communicate with a UE, where transmission of the WUS is based on the determination that the NE has pending data to communicate with the UE. Additionally, the NE 900 may be configured to support any one or combination of the at least one processor configured to cause the NE 900 to transmit the one or more second SSs according to periodicity.

Additionally, the NE 900 may be configured to support any one or combination of the at least one processor configured to cause the NE 900 to transmit a respective second SS of the one or more second SSs prior to communication of the one or more physical channel signals. Additionally, the NE 900 may be configured to support any one or combination of the at least one processor configured to cause the NE 900 to transmit multiple SSBs according to a periodicity, where the periodicity is based on a transmission rate of the WUS.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

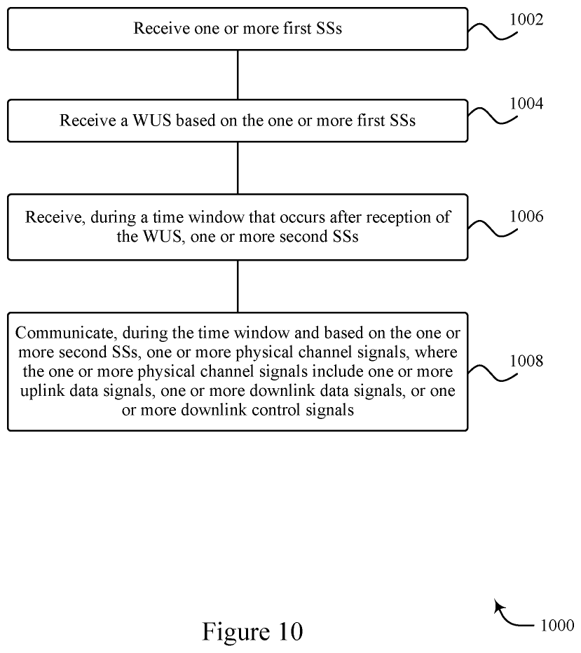

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving one or more first SSs. The operations of 1002 may be performed in accordance with examples as described herein. In some implementations, aspects of the operations of 1002 may be performed by the UE 700 as described with reference to FIG. 7.

At 1004, the method may include receiving a WUS based on the one or more first SSs. The operations of 1004 may be performed in accordance with examples as described herein. In some implementations, aspects of the operations of 1004 may be performed by the UE 700 as described with reference to FIG. 7.

At 1006, the method may include receiving, during a time window that occurs after reception of the WUS, one or more second SSs. The operations of 1006 may be performed in accordance with examples as described herein. In some implementations, aspects of the operations of 1006 may be performed the UE 700 as described with reference to FIG. 7.

At 1008, the method may include communicating, during the time window and based on the one or more second SSs, one or more physical channel signals, where the one or more physical channel signals include one or more uplink data signals, one or more downlink data signals, or one or more downlink control signals. The operations of 1008 may be performed in accordance with examples as described herein. In some implementations, aspects of the operations of 1008 may be performed the UE 700 as described with reference to FIG. 7.

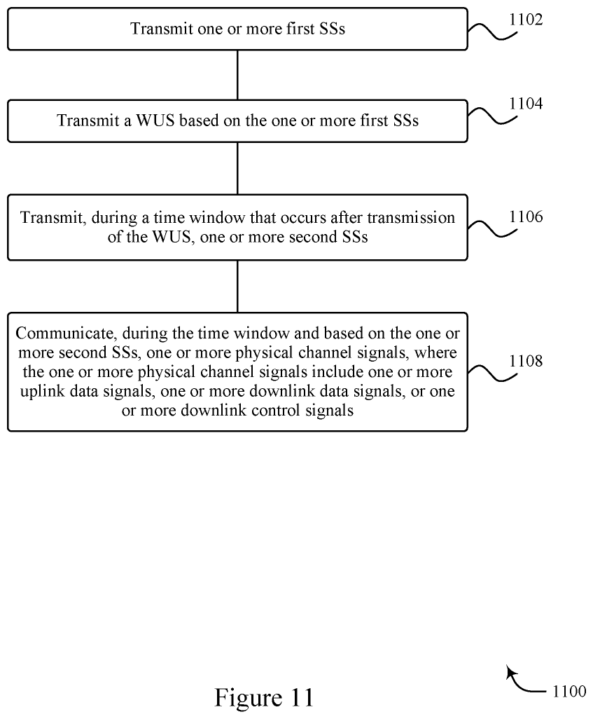

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting one or more first SSs. The operations of 1102 may be performed in accordance with examples as described herein. In some implementations, aspects of the operations of 1102 may be performed by the NE 900 as described with reference to FIG. 9.

At 1104, the method may include transmitting a WUS based on the one or more first SSs. The operations of 1104 may be performed in accordance with examples as described herein. In some implementations, aspects of the operations of 1104 may be performed by the NE 900 as described with reference to FIG. 9.

At 1106, the method may include transmitting, during a time window that occurs after transmission of the WUS, one or more second SSs. The operations of 1106 may be performed in accordance with examples as described herein. In some implementations, aspects of the operations of 1106 may be performed by the NE 900 as described with reference to FIG. 9.

At 1108, the method may include communicating, during the time window and based on the one or more second SSs, one or more physical channel signals, where the one or more physical channel signals include one or more uplink data signals, one or more downlink data signals, or one or more downlink control signals. The operations of 1108 may be performed in accordance with examples as described herein. In some implementations, aspects of the operations of 1108 may be performed by the NE 900 as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive one or more first synchronization signals;
receive a wakeup signal based at least in part on the one or more first synchronization signals;
receive, during a time window that occurs after reception of the wakeup signal, one or more second synchronization signals; and
communicate, during the time window and based at least in part on the one or more second synchronization signals, one or more physical channel signals, wherein the one or more physical channel signals comprise one or more uplink data signals, one or more downlink data signals, or one or more downlink control signals.

2. The UE of claim 1, wherein the at least one processor is further operable to cause the UE to:
initiate a timer based at least in part on the wakeup signal, wherein the time window spans a duration of the timer; or
initiate the timer prior to reception of the one or more first synchronization signals.

3. The UE of claim 2, wherein the duration of the timer comprises an active period of a connected discontinuous reception (DRX) cycle.

4. The UE of claim 2, wherein the at least one processor is operable to cause the UE to:
receive the one or more second synchronization signals until expiration of the timer; or
receive the one or more second synchronization signals until an end of a connected discontinuous reception (DRX) cycle corresponding to the wakeup signal.

5. The UE of claim 2, wherein the wakeup signal comprises a trigger that initiates the timer or reception of the one or more second synchronization signals.

6. The UE of claim 1, wherein the at least one processor is operable to cause the UE to:
receive the one or more second synchronization signals according to periodicity.

7. The UE of claim 1, wherein the at least one processor is operable to cause the UE to:
receive a respective second synchronization signal of the one or more second synchronization signals prior to communication of the one or more physical channel signals.

8. The UE of claim 1, wherein the at least one processor is further operable to cause the UE to:
receive multiple synchronization signal blocks (SSBs) according to a periodicity, wherein the periodicity is based at least in part on a reception rate of the wakeup signal.

9. A network equipment (NE) for wireless communication, comprising:
at least one memory; and
at least one processor coupled with the at least one memory and operable to cause the NE to:
transmit one or more first synchronization signals;
transmit a wakeup signal based at least in part on the one or more first synchronization signals;
transmit, during a time window that occurs after transmission of the wakeup signal, one or more second synchronization signals; and
communicate, during the time window and based at least in part on the one or more second synchronization signals, one or more physical channel signals, wherein the one or more physical channel signals comprise one or more uplink data signals, one or more downlink data signals, or one or more downlink control signals.

10. The NE of claim 9, wherein:
the time window spans a duration of a timer; or
transmission of the one or more first synchronization signals, transmission of the wakeup signal, transmission of the one or more second synchronization signals, and communication of the one or more physical channel signals occur during the duration of the timer.

11. The NE of claim 10, wherein the duration of the timer comprises an active period of a connected discontinuous reception (DRX) cycle.

12. The NE of claim 10, wherein the at least one processor is operable to cause the NE to:
transmit the one or more second synchronization signals until expiration of the timer; or
transmit the one or more second synchronization signals until an end of a connected discontinuous reception (DRX) cycle corresponding to the wakeup signal.

13. The NE of claim 10, wherein the wakeup signal comprises a trigger that initiates the timer or transmission of the one or more second synchronization signals.

14. The NE of claim 9, wherein the at least one processor is further operable to cause the NE to:
determine that the NE has pending data to communicate with a user equipment (UE), wherein transmission of the wakeup signal is based at least in part on the determination that the NE has pending data to communicate with the UE.

15. The NE of claim 9, wherein the at least one processor is operable to cause the NE to:
transmit the one or more second synchronization signals according to periodicity.

16. The NE of claim 9, wherein the at least one processor is operable to cause the NE to:
transmit a respective second synchronization signal of the one or more second synchronization signals prior to communication of the one or more physical channel signals.

17. The NE of claim 9, wherein the at least one processor is further operable to cause the NE to:
transmit multiple synchronization signal blocks (SSBs) according to a periodicity, wherein the periodicity is based at least in part on a transmission rate of the wakeup signal.

18. A method performed by a user equipment (UE), the method comprising:
receiving one or more first synchronization signals;
receiving a wakeup signal based at least in part on the one or more first synchronization signals;
receiving, during a time window that occurs after reception of the wakeup signal, one or more second synchronization signals; and
communicating, during the time window and based at least in part on the one or more second synchronization signals, one or more physical channel signals, wherein the one or more physical channel signals comprise one or more uplink data signals, one or more downlink data signals, or one or more downlink control signals.

19. The method of claim 18, further comprising:
initiating a timer based at least in part on the wakeup signal, wherein the time window spans a duration of the timer; or
initiating the timer prior to reception of the one or more first synchronization signals.

20. A method performed by a network equipment (NE), the method comprising:
transmitting one or more first synchronization signals;
transmitting a wakeup signal based at least in part on the one or more first synchronization signals;
transmitting, during a time window that occurs after transmission of the wakeup signal, one or more second synchronization signals; and
communicating, during the time window and based at least in part on the one or more second synchronization signals, one or more physical channel signals, wherein the one or more physical channel signals comprise one or more uplink data signals, one or more downlink data signals, or one or more downlink control signals.
